(19) United States
(12) Patent Application Publication
(10) Pub. No.: US 2026/0147305 A1
(43) Pub. Date: May 28, 2026

(54) SHEET FEED CONTROL SYSTEM AND SHEET FEED CONTROL METHOD

(71) Applicant: KYOCERA Document Solutions Inc., Osaka (JP)

(72) Inventor: Minori Yamamoto, Osaka (JP)

(21) Appl. No.: 19/396,147

(22) Filed: Nov. 20, 2025

(30) Foreign Application Priority Data
Nov. 28, 2024 (JP) 2024-207165

(51) Int. Cl. G03G 15/00; G03G 21/16

(52) U.S. Cl. CPC G03G 15/70; G03G 15/5029; G03G 15/6529; G03G 21/1638; G03G 2215/00556; G03G 2215/00734

(57) ABSTRACT

A sheet feed control system includes an acquisition part, a first detection part, and a control part. The acquisition part acquires a size of a sheet to be conveyed. The first detection part detects a jam of the sheet. The control part performs, in a case where the jam is detected, either first feed control or second feed control in accordance with the size of the sheet. The first feed control is control to convey the sheet to a position to fit inside a drawer unit including a conveyance path for the sheet and being capable of being pulled out in a direction that intersects with a conveyance direction of the sheet from an apparatus main body of the image forming apparatus. The second feed control is control to convey the sheet to a position to fit outside the drawer unit.

### INCORPORATION BY REFERENCE

This application is based upon and claims the benefit of priority from the corresponding Japanese Patent Application No. 2024-207165 filed on Nov. 28, 2024, the entire contents of which are incorporated herein by reference.

The present disclosure relates to a sheet feed control system and a sheet feed control method.

### BACKGROUND

As a technology in related art, an image forming apparatus that stops all paper in the process of being conveyed and moves the paper stopped in a form of being located in both a drawer unit and a main body to fit inside the drawer unit or the main body in a case where a jam occurs is known. This prevents the paper from being damaged when the drawer unit is pulled out of the main body in this technology in related art.

### SUMMARY

A sheet feed control system according to an aspect of the present disclosure includes an acquisition part, a first detection part, and a control part. The acquisition part acquires a size of a sheet to be conveyed. The first detection part detects a jam of the sheet. The control part performs, in a case where the jam is detected, either first feed control or second feed control in accordance with the size of the sheet. The first feed control is control to convey the sheet to a position to fit inside a drawer unit including a conveyance path for the sheet and being capable of being pulled out in a direction that intersects with a conveyance direction of the sheet from an apparatus main body of the image forming apparatus. The second feed control is control to convey the sheet to a position to fit outside the drawer unit.

A sheet feed control method according to another aspect of the present disclosure includes an acquisition step, a detection step, and a control step. In the acquisition step, a size of a sheet to be conveyed is acquired. In the detection step, a jam of the sheet is detected. In the control step, in a case where the jam is detected, either first feed control or second feed control is performed in accordance with the size of the sheet. The first feed control is control to convey the sheet to a position to fit inside a drawer unit including a conveyance path for the sheet and being capable of being pulled out in a direction that intersects with a conveyance direction of the sheet from an apparatus main body of the image forming apparatus. The second feed control is control to convey the sheet to a position to fit outside the drawer unit.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF FIGURES

FIG. 1 is a schematic view showing a configuration of an image processing apparatus according to an embodiment.

FIG. 2 is a block diagram showing a configuration of the image processing apparatus according to the embodiment.

FIG. 3 is a schematic view showing a configuration of a drawer unit and a peripheral portion of the drawer unit according to the embodiment.

FIG. 4 is a flowchart showing an operation example of a sheet feed control system according to the embodiment.

FIG. 5 is a view showing a first operation example of the sheet feed control system according to the embodiment.

FIG. 6 is a view showing a second operation example of the sheet feed control system according to the embodiment.

FIG. 7 is a view showing a third operation example of the sheet feed control system according to the embodiment.

FIG. 8 is a view showing a fourth operation example of the sheet feed control system according to the embodiment.

FIG. 9 is a view showing a fourth operation example of the sheet feed control system according to the embodiment.

### DETAILED DESCRIPTION

Hereinafter, an embodiment of the present disclosure will be described with reference to the accompanying drawings. The following embodiment is an example embodying the present disclosure and is not intended to limit the technical scope of the present disclosure.

### [1] Overall Configuration of Image Forming Apparatus

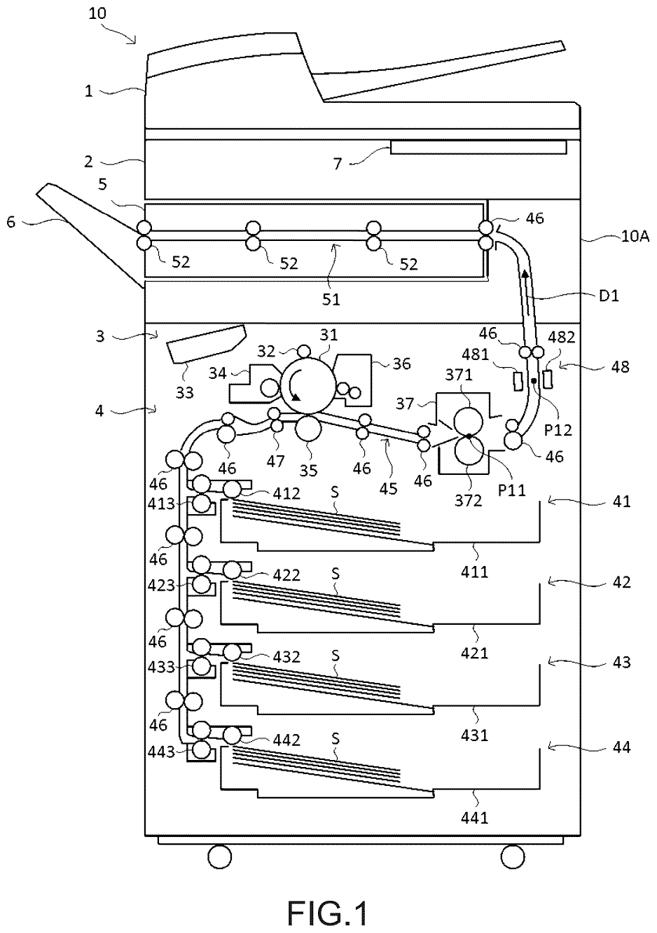

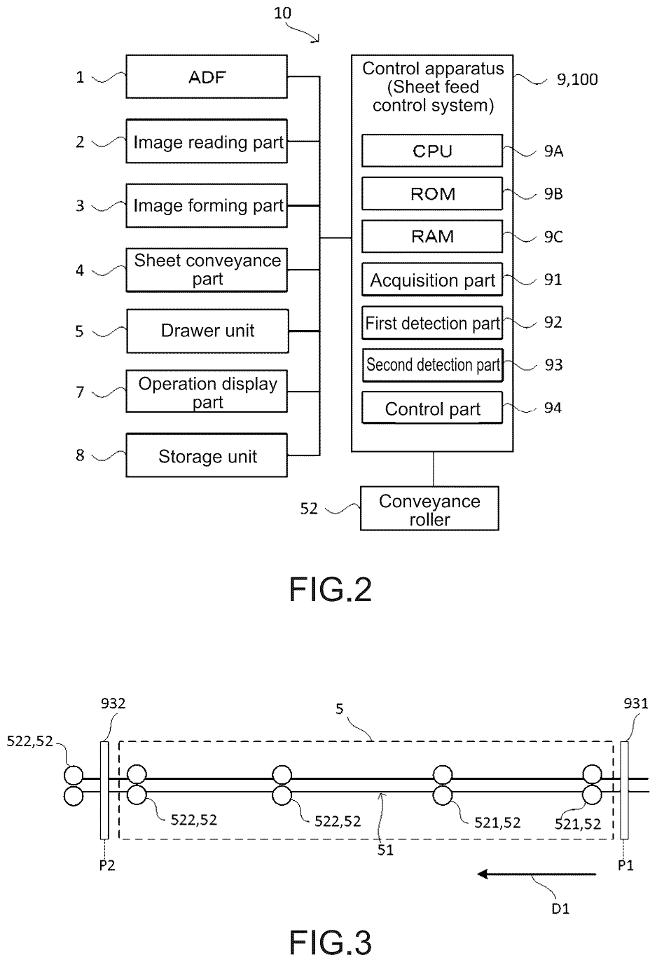

First of all, an image forming apparatus 10 according to the present embodiment will be described with reference to FIGS. 1 and 2. FIG. 1 is a cross-sectional schematic view of the image forming apparatus 10. It should be noted that in the following description, the front side of the figure is defined as a front side of the image forming apparatus 10 and the deep side of the figure is defined as a rear side of the image forming apparatus 10. As a matter of course, the above direction definitions are not intended to limit use modes of the image forming apparatus 10.

In the present embodiment, as an example, the image forming apparatus 10 is a multifunction peripheral that has a plurality of function, such as a scan function, a facsimile function, and a copying machine function, as well as a printer function of forming images on the basis of image data. It should be noted that for example, the image forming apparatus 10 may be an apparatus, such as a printer apparatus, a facsimile apparatus, or a copying machine.

As shown in FIGS. 1 and 2, the image forming apparatus 10 includes an automatic document feeder (ADF) 1, an image reading part 2, an image forming part 3, a sheet conveyance part 4, a drawer unit 5, an output tray 6, an operation display part 7, a storage unit 8, and a control apparatus 9.

The ADF 1 includes an document set part, a plurality of conveyance rollers, a document cover, and a paper output part (not shown). The ADF 1 conveys a document to be read by the image reading part 2.

The image reading part 2 includes a document glass, a light source, a plurality of mirrors, an optical lens, and a charge-coupled device (CCD) (not shown). The image reading part 2 is capable of reading image data from a document.

The image forming part 3 is capable of performing image forming processing (printing processing) of forming an image by an electrophotographic method on the basis of the image data read by the image reading part 2. Moreover, the image forming part 3 is also capable of performing the printing processing on the basis of image data input from an information processing apparatus, such as an external personal computer. Specifically, the image forming part 3 includes a photosensitive drum 31, a charging apparatus 32, a light scan apparatus 33, a developing apparatus 34, a transfer roller 35, a cleaning apparatus 36, a fusing apparatus 37, and an output part 38 as shown in FIG. 1.

The sheet conveyance part 4 conveys sheets S to a conveyance path 51 inside the drawer unit 5 via an image forming position by the image forming part 3. As shown in FIG. 1, the sheet conveyance part 4 includes feeding units 41 to 44, a sheet conveyance path 45, a plurality of conveyance rollers 46, resist rollers 47, and a first optical sensor 48.

The feeding unit 41 includes a cassette 411, a pick-up roller 412, and feed rollers 413. Similarly, the feeding units 42 to 44 include cassettes 421 to 441, pick-up rollers 422 to 442, and feed rollers 423 to 443. Various sizes of sheets S are placed in the cassettes 411 to 441. The sheets S are paper, coated paper, postcards, envelopes, overhead projector (OHP) sheets, or the like. The feeding units 41 to 44 are configured to be connectable to a casing that houses the components of the image forming part 3 and to other feeding units.

The sheet conveyance path 45 is a movement passageway for the sheets S to be conveyed by the sheet conveyance part 4. For example, the sheet conveyance path 45 is formed by a pair of guide members provided inside the casing that houses the components of the image forming part 3. The sheet conveyance path 45 connects each of the cassettes 411 to 441 to the conveyance path 51 inside the drawer unit 5. The sheet conveyance path 45 is provided with the plurality of conveyance rollers 46 used for conveying the sheets S, and the resist rollers 47. In the sheet conveyance part 4, the sheets S are conveyed on the sheet conveyance path 45 in a conveyance direction D1 (see FIG. 1) by the plurality of conveyance rollers 46.

The first optical sensor 48 is capable of detecting the presence/absence of the sheets S at a detection position P12 shown in FIG. 1. For example, the first optical sensor 48 is a transmission type optical sensor having a light-emitting part 481 and a light receiving part 482. In the first optical sensor 48, for example, when no sheet S is present at the detection position P12, light emitted from the light-emitting part 481 is emitted to the light receiving part 482. On the other hand, in the first optical sensor 48, when a sheet S is present at the detection position P12, light emitted from the light-emitting part 481 is not emitted to the light receiving part 482, blocked by the sheet S. Accordingly, the light receiving part 482 outputs an electrical signal depending on the presence/absence of the sheet S at the detection position P12. The electrical signal output from the light receiving part 482 is input to the control apparatus 9 and is used for detection or the like of the occurrence of a jam (paper jam) of the sheets S to be described later. It should be noted that the first optical sensor 48 only needs to be capable of detecting the presence/absence of the sheet S at the detection position P12, and for example, the first optical sensor 48 may be a reflective optical sensor or may be a ultrasonic sensor or the like.

In the image forming part 3, an image is formed on a sheet S conveyed by the sheet conveyance part 4 in the following procedure.

First of all, the charging apparatus 32 uniformly charges the surface of the photosensitive drum 31 at a predetermined potential. Next, the light scan apparatus 33 emits light based on image data to the surface of the photosensitive drum 31. Accordingly, an electrostatic latent image corresponding to the image data is formed on the surface of the photosensitive drum 31. Then, the electrostatic latent image formed on the surface of the photosensitive drum 31 is developed (visualized) as a toner image by the developing apparatus 34. The photosensitive drum 31 rotating the arrow direction shown in FIG. 1 conveys the toner image formed by the developing apparatus 34 to a transfer position (image forming position) of the transfer roller 35.

On the other hand, the sheet conveyance part 4 performs an operation of conveying the sheet to the image forming position in parallel with an image forming operation by the image forming part 3. For example, when a sheet S stored in the feeding unit 41 is selected as printing paper, the sheet S stored in the cassette 411 is lifted to a contact position with the pick-up roller 412 by a lift plate (not shown) provided at the bottom of the cassette 411. The pick-up roller 412 picks up the top-layer sheet S lifted to the contact position. The sheet S picked up by the pick-up roller 412 is conveyed by the feed rollers 413 and the conveyance rollers 46 to a location where the resist rollers 47 are arranged.

The resist rollers 47 send the sheet S to the image forming position in accordance with a conveyance timing when the photosensitive drum 31 conveys the toner image to the image forming position. For example, the sheet conveyance path 45 is provided with a sensor (not shown) that detects the passage of the sheets S. This sensor is located at a position on a farther upstream side in the conveyance direction D1 than the location where the resist rollers 47 are arranged. On the basis of a detection timing of the passage of the sheet S by the sensor, the control apparatus 9 sets a sending timing when the resist rollers 47 sends the sheet S, which matches the conveyance timing. Then, the resist rollers 47 send the sheet S to the image forming position on the basis of the sending timing set by the control apparatus 9. Accordingly, the transfer roller 35 transfers the toner image conveyed at the conveyance timing onto the surface of the sheet S sent to the image forming position at the sending timing.

It should be noted that toner remaining on the surface of the photoconductor drum 31 after the transfer of the toner image by the transfer roller 35 is removed by the cleaning apparatus 36. For example, in the cleaning apparatus 36, the toner remaining on the surface of the photoconductor drum 31 is removed by a blade-shaped cleaning member. Then, the toner removed by the cleaning member is conveyed and collected to a toner storage container (not shown) by a conveyance screw.

The sheet S on which the toner image has been transferred at the image forming position is conveyed to the fusing apparatus 37 by the conveyance rollers 46. In the fusing apparatus 37, the toner image transferred to the sheet S is heated and pressed at a fusing position P11 where a heating roller 371 and a pressure roller 372 are held in contact. Accordingly, the toner image is fused to the sheet S. The sheet S on which the toner image has been fused by the fusing apparatus 37 is conveyed by the conveyance rollers 46 to the conveyance path 51 inside the drawer unit 5.

The drawer unit 5 is a unit that includes the conveyance path 51 for the sheet S and is configured to be capable of being pulled out of an apparatus main body 10A of the image forming apparatus 10 in a direction (here, front-rear direction) that intersects with the conveyance direction D1 of the sheet S. Specifically, the drawer unit 5 includes guide rollers (not shown) and rails (not shown) that support the guide rollers to be capable of travelling and is configured to be pulled out of the apparatus main body 10A by the user sliding the drawer unit 5 forwards. By enabling the drawer unit 5 to be pulled out of the apparatus main body 10A as such, the user can take the following measures. For example, assume that a jam (paper jam) of a sheet S occurs in the sheet conveyance part 4 in the process of conveying a plurality of sheets S. In this case, the user can take measures, e.g., removing the remaining unjammed sheets S by pulling the drawer unit 5 out of the apparatus main body 10A without damaging the sheets.

As shown in FIG. 1, the drawer unit 5 includes the conveyance path 51 and a plurality of conveyance rollers 52. In the drawer unit 5, the sheet S is conveyed by the plurality of conveyance rollers 52 in the conveyance direction D1 on the conveyance path 51. Accordingly, the sheet S is output to the output tray 6.

The operation display part 7 is a user interface of the image forming apparatus 10. The operation display part 7 includes a display unit and an operation unit. The display unit displays various types of information in accordance with control instructions from the control apparatus 9. For example, the display unit is a liquid-crystal display. The operation unit inputs various types of information to the control apparatus 9 in accordance with the user's operations. For example, the operation unit is an operation key or a touch panel.

The storage unit 8 is a nonvolatile storage device. Examples of the storage unit 8 include nonvolatile memories, such as flash memory and EEPROM (registered trademark), and storage devices, such as solid state drive (SSD) and hard disk drive (HDD).

The control apparatus 9 comprehensively controls the image forming apparatus 10. Moreover, the control apparatus 9 functions as a sheet feed control system 100 to be described later. As shown in FIG. 2, the control apparatus 9 includes a CPU 9A, a ROM 9B, and a RAM 9C. The CPU 9A is a processor that executes various types of arithmetic processing. The ROM 9B is a nonvolatile storage device in which information such as control programs for causing the CPU 9A to execute various types of processing is prestored. The RAM 9C is a volatile storage device used as a temporary storage memory (work area) for various types of processing executed by the CPU 9A.

In the control apparatus 9, various control programs prestored in the ROM 9B are executed by the CPU 9A. In this manner, the image forming apparatus 10 is comprehensively controlled by the control apparatus 9 and the control apparatus 9 functions as the sheet feed control system 100. It should be noted that the control apparatus 9 may be constituted by an electronic circuit, such as an application specific integrated circuit (ASIC). Moreover, the control apparatus 9 may be a control part provided separately from a main control part that comprehensively controls the image forming apparatus 10.

By the way, in an image forming apparatus like the image forming apparatus 10, a sheet jam may occur at any point on the conveyance path for example during the conveyance of a plurality of sheets. In this case, the user can take measures, e.g., removing the remaining unjammed sheets by pulling the drawer unit out of the apparatus main body without damaging the sheets. Here, if a sheet has been stopped in a form of being located in both the drawer unit and the apparatus main body in a case where a jam occurs, the sheet may be damaged when the drawer unit is pulled out. In view of this, a configuration that stops all paper in the process of being conveyed in a case where a jam occurs and moves paper stopped in a form of being located in both the drawer unit and the main body to fit inside the drawer unit or the main body is known as a technology in related art. This prevents the paper from being damaged when the drawer unit is pulled out of the main body in this configuration.

However, in this technology in related art, a position of a sheet (paper) in the process of being conveyed is detected on the basis of information from paper detectors provided at a plurality of positions, and then the paper stopped in a form of being located in both the drawer unit and the main body is moved to fit inside the drawer unit or the main body. That is, in this technology in related art, the accuracy of determining the sheet position depends on the number of paper detectors. Therefore, this technology in related art has a problem in that reducing the number of paper detectors for reducing costs makes it harder to determine the sheet position, so it is difficult to move the sheet to a position where the sheet will not be damaged when the drawer unit is pulled out.

That is, in this technology in related art, a plurality of sensors for identifying a sheet position is arranged in the apparatus main body, thereby determining a position of a stopped sheet on the basis of detection results of the sensors. Then, in this technology in related art, the sheet is moved to be removed from the drawer unit or fit inside the drawer unit in accordance with the determined position of the stopped sheet. However, this configuration has a problem in that many sensors are required to determine a sheet position, which tends to increase costs. This configuration also has a problem in that reducing the number of paper sensors for reducing costs makes it harder to determine the sheet position because the accuracy of determining the sheet position depends on the number of sensors. This tends to increase the likelihood that the sheet will not be conveyed to the proper position and will be damaged when the drawer unit is pulled out.

In this regard, in the present embodiment, processing executed by the sheet feed control system 100 of the image forming apparatus 10 to be described below can realize the sheet feed control system 100 and a sheet feed control method that allow the sheet S to be easily moved to a position where the sheet S will not be damaged when the drawer unit 5 is pulled out, while reducing costs.

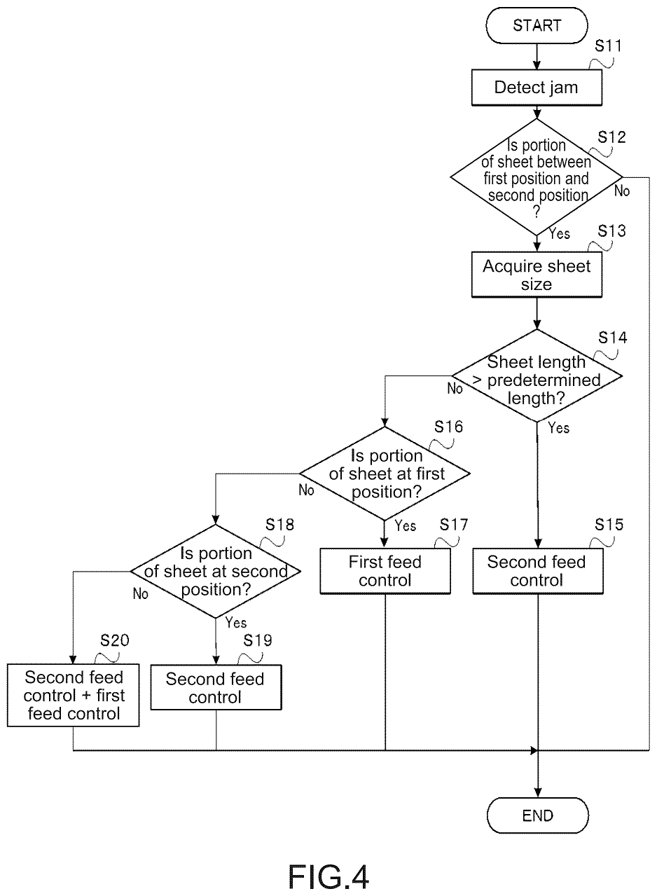

Specifically, a program for causing the CPU 9A to perform sheet feed control (see FIG. 4) to be described below is prestored in the ROM 9B of the control apparatus 9. It should be noted that the program may be recorded on a computer-readable recording medium, such as a CD, DVD, or flash memory, and may be read from the recording medium and installed in the storage unit 8.

As shown in FIG. 2, the control apparatus 9 (sheet feed control system 100) includes an acquisition part 91, a first detection part 92, a second detection part 93, and a control part 94. Specifically, the control apparatus 9 executes the program stored in the ROM 9B by using the CPU 9A. In this manner, the control apparatus 9 functions as the acquisition part 91, the first detection part 92, the second detection part 93, and the control part 94.

The acquisition part 91 acquires a size of the sheet S to be conveyed. In the present embodiment, the size of the sheet S is a length of the sheet S in the conveyance direction D1. For example, when an execution instruction of a job, such as printing the sheet S, is input by the user's operation on the operation display part 7, the acquisition part 91 executes processing of acquiring the size of the sheet S. In this processing, the acquisition part 91 acquires the size of the sheet S by reading the size of the sheet S prestored in the storage unit 8, which is input by the user on the operation display part 7 before executing the job. It should be noted that the acquisition part 91 may acquire the size of the sheet S when the user makes an input to specify the size of the sheet S on the operation display part 7.

The first detection part 92 detects a jam of the sheet S. Specifically, the first detection part 92 detects the occurrence of a jam of the sheet S on the sheet conveyance path 45 on the basis of a detection result of the first optical sensor 48. In other words, the first detection part 92 detects a jam of the sheet S in a location other than the conveyance path 51 of the drawer unit 5. Specifically, the first detection part 92 determines that a jam of the sheet S has occurred on the sheet conveyance path 45 for example in a case where no electrical signal indicating the detection of sheet S is input from the light receiving part 482 in a predetermined allowable time after sheet S is sent.

It should be noted that when the first detection part 92 detects the occurrence of a jam of the sheet S, the first detection part 92 may cause the operation display part 7 to display a message indicating this. This enables the user to recognize the occurrence of a jam of the sheet S and take measures, e.g., removing the jammed sheet S from the apparatus main body 10A.

The second detection part 93 detects the presence/absence of the sheet S at a first position P1 (see FIG. 3) and a second position P2 (see FIG. 3). Here, as shown in FIG. 3, the first position P1 is a position on a farther upstream side (right side in FIG. 3) in the conveyance direction D1 than the drawer unit 5. Moreover, as shown in FIG. 3, the second position P2 is a position on a farther downstream side (left side in FIG. 3) in the conveyance direction D1 than the drawer unit 5. Specifically, the second detection part 93 detects the presence/absence of the sheet S at the first position P1 by acquiring a detection result of a first sensor 931. Moreover, the second detection part 93 detects the presence/absence of the sheet S at the second position P2 by acquiring a detection result of the second sensor 932.

For example, the first sensor 931 is a sensor similar to the first optical sensor 48 and detects the presence/absence of the sheet S at the first position P1 shown in FIG. 3. For example, the second sensor 932 is a sensor similar to the first optical sensor 48 and detects the presence/absence of the sheet S at second position P2 shown in FIG. 3.

When a jam of the sheet S is detected by the first detection part 92, the control part 94 performs either the first feed control or the second feed control in accordance with the size of the sheet S acquired by the acquisition part 91. In the present embodiment, the conveyance rollers driven in the first feed control and the second feed control include four pairs of conveyance rollers 52 located inside the drawer unit 5 and one pair of conveyance roller 52 located on a farther downstream side in the conveyance direction D1 than the drawer unit 5 as shown in FIG. 3. Moreover, in the present embodiment, the conveyance rollers driven in the first feed control and the second feed control are roughly classified into two pairs of first conveyance rollers 521 located on the upstream side in the conveyance direction D1 and three pairs of second conveyance rollers 522 located on the downstream side in the conveyance direction D1. In other words, the drawer unit 5 includes the first conveyance rollers 521 located on a farther upstream side in the conveyance direction D1 than the center of the drawer unit 5 and the second conveyance rollers 522 located on a farther downstream side in the conveyance direction D1 than the center of the drawer unit 5.

In the present embodiment, the control part 94 is capable of individually driving or stopping each conveyance roller 52 by controlling a motor (not shown) arranged for each conveyance roller 52. It should be noted that in a case where each conveyance roller 52 is configured to be capable of being driven by a single motor, the control part 94 may individually drive or stop each conveyance roller 52 by controlling a clutch (not shown) arranged for each conveyance roller 52.

The first feed control is control to moving the sheet S to a position where the sheet S fits inside the drawer unit 5. The first feed control can be performed, for example, in a case where the length of the sheet S in the conveyance direction D1 is shorter than a predetermined length, i.e., in a case where the entire sheet S fits inside the drawer unit 5. The second feed control is control to move the sheet S to a position where the sheet S fits outside the drawer unit 5. The second feed control can be performed, for example, in a case where the length of the sheet S in the conveyance direction D1 is longer than the predetermined length, i.e., in a case where the entire sheet S does not fit inside the drawer unit 5.

Here, the predetermined length is set to be such a length that the entire sheet S can fit inside the drawer unit 5 after, for example, only some of the conveyance rollers 52 are driven to convey the sheet S. For example, assume that the sheet S is stopped on the upstream side in the conveyance direction D1 and only the first conveyance rollers 521 are driven to move the sheet S in FIG. 3. In this case, a downstream end portion of the sheet S is present on a farther downstream side than the first conveyance rollers 521 located on the farthest downstream side. Therefore, the predetermined length only needs to be such a length that the entire sheet S fits inside the drawer unit 5 in this state.

In the present embodiment, the predetermined length is set to about 279 mm on the basis of letter size. As a matter of course, the predetermined length may be set based on an international standard (e.g., ISO 216, etc.) that defines the dimensions of paper, such as A4, for example. Moreover, the predetermined length may be set as appropriate in accordance with a length of the drawer unit 5 in the conveyance direction D1, the number of conveyance rollers 52, a distance between the conveyance rollers 52 in the conveyance direction D1, and the like.

In the present embodiment, the control part 94 performs the second feed control in a case where the length of the sheet S in the conveyance direction D1 is longer than the predetermined length (i.e., the length of the drawer unit 5 in the conveyance direction D1). Accordingly, the entire sheet S is removed from the drawer unit 5, which provides an advantage that the sheet S is less likely to be damaged when the drawer unit 5 is pulled out. Moreover, the control part 94 performs either the first feed control or the second feed control in a case where the length of the sheet S in the conveyance direction D1 is shorter than the predetermined length. Accordingly, the entire sheet S fits inside the drawer unit 5, which provides an advantage that the sheet S is less likely to be damaged when the drawer unit 5 is pulled out. It should be noted that whether to perform either the first feed control or the second feed control is determined on the basis of a condition other than the size of the sheet S. The control contents of the sheet feed control (first feed control and second feed control) will be described in detail in the section “[2] Operation example of sheet feed control system” to be described later.

Moreover, in the present embodiment, the control part 94 performs either the first feed control or the second feed control in a case where the second detection part 93 has detected that at least a portion of the sheet S is present between the first position P1 and the second position P2. That is, the control part 94 performs the sheet feed control in a case where the sheet S is stopped in a form of being located in both the drawer unit 5 and the apparatus main body 10A, but the control part 94 does not perform the sheet feed control in other cases. Accordingly, the sheet feed control is not performed in the situation where the sheet S cannot be damaged when the drawer unit 5 is pulled out, which provides an advantage that unnecessary control can be avoided.

Specifically, in a case where only a detection result of the first sensor 931 indicates the presence of a sheet S, the second detection part 93 detects that the downstream end portion of the sheet S in the conveyance direction D1 is present between the first position P1 and the second position P2. Moreover, in a case where only a detection result of the second sensor 932 indicates the presence of a sheet S, the second detection part 93 detects that an upstream end portion of the sheet S in the conveyance direction D1 is present between the first position P1 and the second position P2. Moreover, in a case where a detection result of the first sensor 931 indicates the passage of the sheet S and a detection result of the second sensor 932 indicates the absence of the sheet S, the second detection part 93 detects that the entire sheet S is present between the first position P1 and the second position P2.

### [2] Operation Example of Sheet Feed Control System

Hereinafter, an example of the procedure of processing executed by the control apparatus 9 (sheet feed control system 100) in the image forming apparatus 10 and an example of the sheet feed control method according to the present embodiment will be described with reference to FIG. 4. Here, Steps S11, S12, and so on represent the number of the processing procedure (steps) executed by the sheet feed control system 100.

### Step S11

First of all, the first detection part 92 detects a jam of the sheet S. Here, the first detection part 92 detects a jam of the sheet S on the sheet conveyance path 45 of the sheet conveyance part 4. It should be noted that in a case where the first detection part 92 has detected no jam of the sheet S, processing in Step S12 and the subsequent described below is not performed.

### Step S12

Next, the second detection part 93 detects whether or not at least a portion of the sheet S is present between the first position P1 and the second position P2. In other words, the second detection part 93 detects whether or not the sheet S has been stopped in a form of being located in both the drawer unit 5 and the apparatus main body 10A. In a case where at least a portion of the sheet S is present between the first position P1 and the second position P2 (Step S12: Yes), Step S13 to be described below is performed. On the other hand, in a case where the sheet S is not present between the first position P1 and the second position P2 (Step S12: No), processing in Step S12 and the subsequent described below is not performed.

### Step S13

Next, the acquisition part 91 acquires a size of the sheet S. Here, the acquisition part 91 acquires a length of the sheet S in the conveyance direction D1 as a size of the sheet S.

### Step S14

Next, the control part 94 compares the length of the sheet S in the conveyance direction D1, which has been acquired by the acquisition part 91, with a predetermined length. In a case where the length of the sheet S in the conveyance direction D1 is longer than the predetermined length (Step S14: Yes), the control part 94 performs Step S15 to be described below. On the other hand, in a case where the length of the sheet S in the conveyance direction D1 is shorter than or equal to the predetermined length (Step S14: No), the control part 94 performs Step S16 to be described below.

### Step S15

The control part 94 performs the second feed control. That is, the control part 94 conveys the sheet S so that the entire sheet S is removed from the drawer unit 5 by controlling the one or more conveyance rollers 52. The operation of the control part 94 at Step S15 corresponds to a first operation example to be described later.

### Step S16

The control part 94 determines whether or not a portion of the sheet S is present at the first position P1 on the basis of a detection result of the second detection part 93. In a case where a portion of the sheet S is present at the first position P1 (Step S16: Yes), the control part 94 performs Step S17 to be described below. On the other hand, in a case where the sheet S is not present at the first position P1 (Step S16: No), the control part 94 performs Step S18 to be described below.

### Step S1

The control part 94 performs the first feed control. That is, the control part 94 conveys the sheet S so that the entire sheet S fits inside the drawer unit 5 by controlling the one or more conveyance rollers 52. The operation of the control part 94 at Step S17 corresponds to a second operation example to be described later.

### Step S18

The control part 94 determines whether or not a portion of the sheet S is present at the second position P2 on the basis of a detection result of the second detection part 93. In a case where a portion of the sheet S is present at the second position P2 (Step S18: Yes), the control part 94 performs Step S19 to be described below. On the other hand, in a case where the sheet S is not present at the second position P2 (Step S18: No), the control part 94 performs Step S20 to be described below.

### Step S19

The control part 94 performs the second feed control. That is, the control part 94 conveys the sheet S so that the entire sheet S is removed from the drawer unit 5 by controlling the one or more conveyance rollers 52. The operation of the control part 94 at Step S19 corresponds to a third operation example to be described later.

### Step S20

The control part 94 first performs the second feed control, and then performs the first feed control. That is, the control part 94 first attempts to perform control to convey the sheet S so that the entire sheet S is removed from the drawer unit 5 by controlling the one or more conveyance rollers 52. Then, the control part 94 attempts to perform control to convey the sheet S so that the entire sheet S fits inside the drawer unit 5. The operation at Step S20 corresponds to a fourth operation example to be described later.

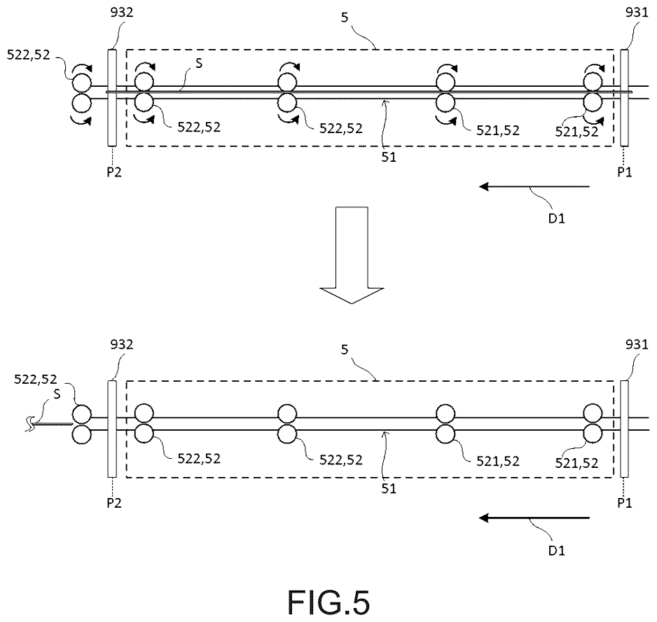

Hereinafter, specific operation examples of the sheet feed control system 100 will be described with reference to FIGS. 5 to 9.

### (1) First Operation Example

As shown in FIG. 5, the first operation example is an operation example of the control part 94 in a case where the length of the sheet S in the conveyance direction D1 is longer than the predetermined length. In the first operation example, the control part 94 performs the second feed control. Then, in a case where the control part 94 performs the second feed control, the control part 94 drives all the conveyance rollers 52. In other words, in a case where the control part 94 performs the second feed control, the control part 94 drives all the conveyance rollers 52 located inside the drawer unit 5. Accordingly, the sheet S is conveyed until the upstream end portion of the sheet S is present on a farther downstream side than the second conveyance rollers 522 located on the farthest downstream side. Therefore, the entire sheet S is removed from the drawer unit 5, which provides an advantage that the sheet S is less likely to be damaged when the drawer unit 5 is pulled out.

### (2) Second Operation Example

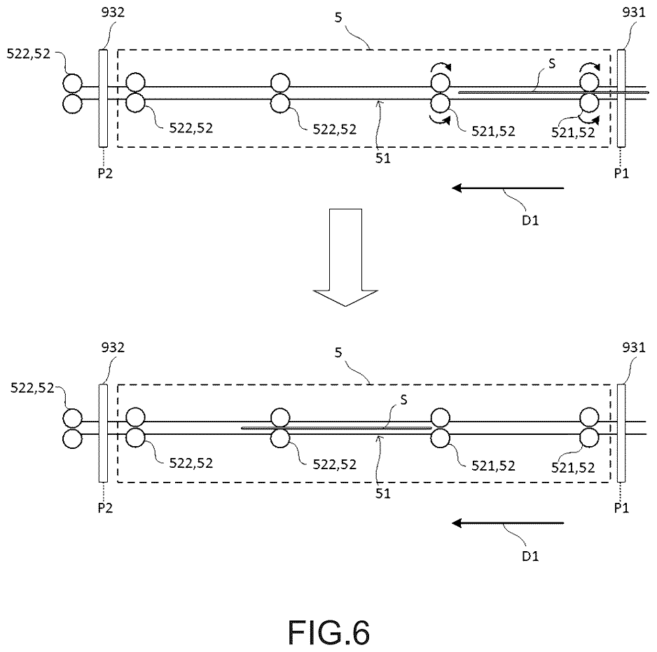

As shown in FIG. 6, the second operation example is an operation example of the control part 94 in a case where the length of the sheet S in the conveyance direction D1 is shorter than or equal to the predetermined length and a portion of the sheet S is present at the first position P1. In the second operation example, the control part 94 performs the first feed control. Then, as shown in FIG. 6, in a case of performing the first feed control, the control part 94 drives the first conveyance rollers 521 and stops the second conveyance rollers 522. Accordingly, the sheet S is conveyed until the upstream end portion of the sheet S is present on the farther downstream side than the first conveyance rollers 521 located on the farthest downstream side and the downstream end portion of the sheet S is present on a farther upstream side than a downstream end portion of the drawer unit 5. Therefore, the entire sheet S fits inside the drawer unit 5, which provides an advantage that the sheet S is less likely to be damaged when the drawer unit 5 is pulled out.

### (3) Third Operation Example

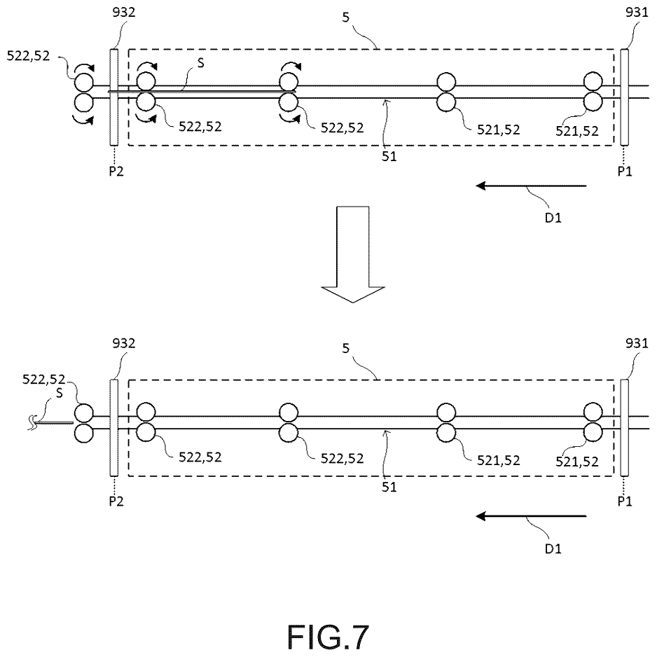

As shown in FIG. 7, the third operation example is an operation example of the control part 94 in a case where the length of the sheet S in the conveyance direction D1 is shorter than or equal to the predetermined length and a portion of the sheet S is present at the second position P2. In the third operation example, the control part 94 performs the second feed control. Then, in a case where the control part 94 performs the second feed control, the control part 94 stops the first conveyance rollers 521 and drives the second conveyance rollers 522. Accordingly, the sheet S is conveyed until the upstream end portion of the sheet S is present on the farther downstream side than the second conveyance rollers 522 located on the farthest downstream side. Therefore, the entire sheet S is removed from the drawer unit 5, which provides an advantage that the sheet S is less likely to be damaged when the drawer unit 5 is pulled out.

### (4) Fourth Operation Example

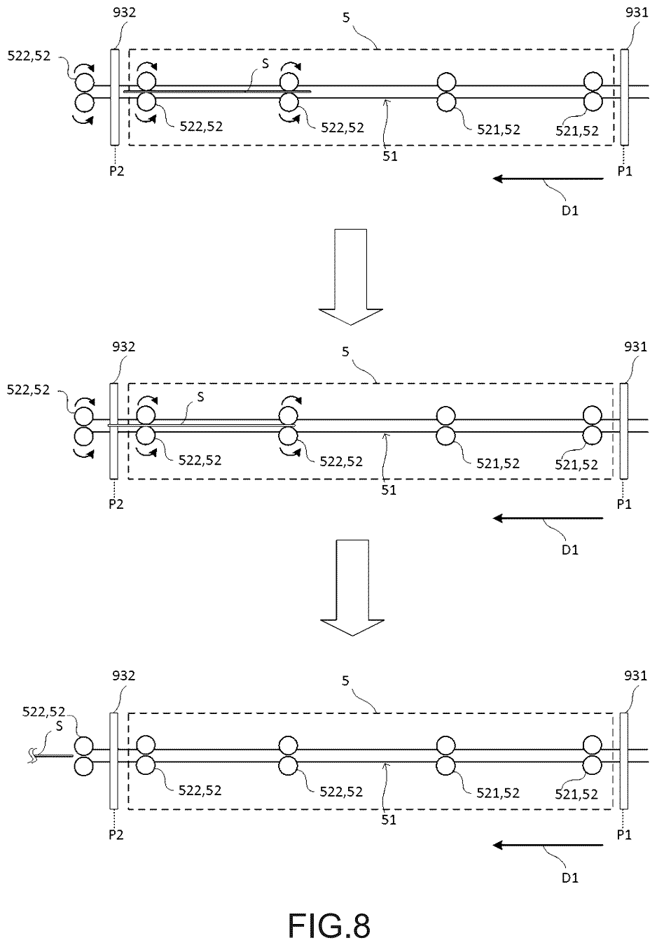

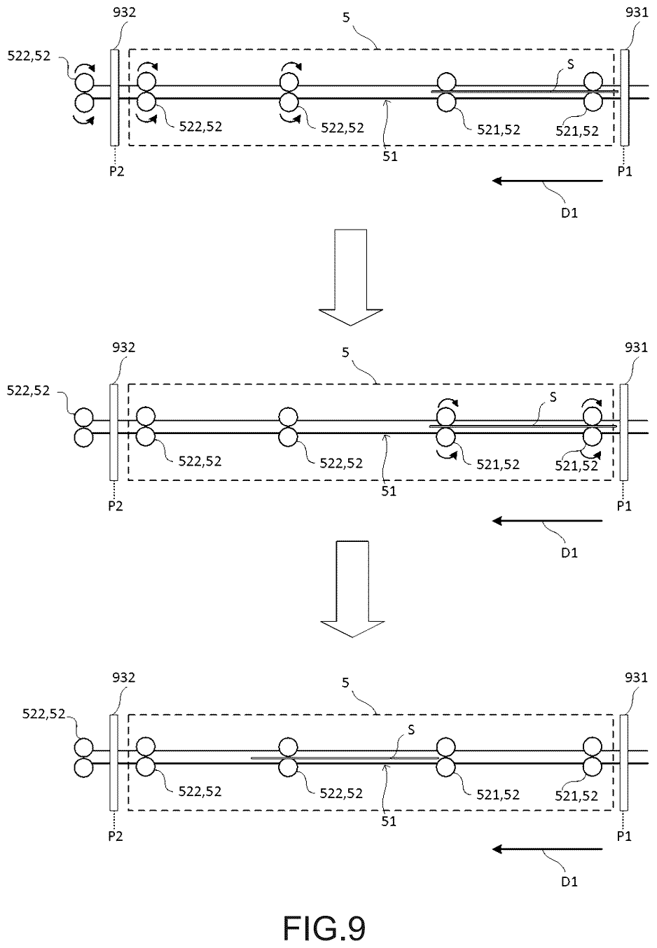

As shown in FIGS. 8 and 9, the fourth operation example is an operation example of the control part 94 in a case where the length of the sheet S in the conveyance direction D1 is shorter than or equal to the predetermined length and the sheet S is not present at either the first position P1 or the second position P2. In the fourth operation example, as shown in FIG. 8, the control part 94 first performs the second feed control. Then, in a case where the control part 94 performs the second feed control, the control part 94 stops the first conveyance rollers 521 and drives the second conveyance rollers 522. As shown in FIG. 8, in a case where a portion of the sheet S is present at the position where the sheet S is sandwiched between the second conveyance rollers 522, the sheet S is conveyed until the upstream end portion of the sheet S is present on the farther downstream side than the second conveyance rollers 522 located on the farthest downstream side. Therefore, the entire sheet S is removed from the drawer unit 5, which provides an advantage that the sheet S is less likely to be damaged when the drawer unit 5 is pulled out.

On the other hand, in a case where the sheet S is not present at the position where the sheet S is sandwiched between the second conveyance rollers 522, the sheet S is not conveyed by the second feed control and remains in the drawer unit 5. In view of this, in the fourth operation example, the control part 94 next performs the first feed control as shown in FIG. 9. Here, in a case where it is not detected that the sheet S is present at the second position P2 after the second feed control is performed, the control part 94 performs the first feed control. Then, in a case of performing the first feed control, the control part 94 drives the first conveyance rollers 521 and stops the second conveyance rollers 522. As shown in FIG. 9, in a case where a portion of the sheet S is present at the position where the sheet S is sandwiched between the first conveyance rollers 521, the sheet S is conveyed to the following position. This position is a position where the upstream end portion of the sheet S is present on the farther downstream side than the first conveyance rollers 521 located on the farthest downstream side and the downstream end portion of the sheet S is present on the farther upstream side than the downstream end portion of the drawer unit 5. Therefore, the entire sheet S fits inside the drawer unit 5, which provides an advantage that the sheet S is less likely to be damaged when the drawer unit 5 is pulled out.

As described above, in the sheet feed control system 100 according to the present embodiment, in a case where a jam of the sheet S is detected, either the first feed control or the second feed control is performed in accordance with the size of the sheet S. Therefore, in the sheet feed control system 100 according to the present embodiment, it is possible to determine whether to move the sheet S to fit inside the drawer unit 5 or to move the sheet S to be removed from the drawer unit 5 in accordance with the size of the sheet S. Therefore, the sheet feed control system 100 according to the present embodiment has an advantage that the sheet S is easily moved to a position where the sheet S will not be damaged when the drawer unit 5 is pulled out. Moreover, the sheet feed control system 100 according to the present embodiment does not require many sensors to determine the position of the sheet S, which provides an advantage that costs can be easily reduced.

### [3] Modified Examples

In the present embodiment, a plurality of jobs related to a plurality of sheets S of different sizes may be specified to the image forming apparatus 10. Specifically, a job of printing a sheet S with a first size and a job of printing a sheet S with a second size may be specified to the image forming apparatus 10, and these jobs may be sequentially performed. In such a case, the sheet feed control system 100 acquires a size of each of the plurality of sheets S, so there is a problem in that it is difficult to perform the sheet feed control depending on the size of the sheet S. In view of this, in a case where sheets S of different sizes are continuously conveyed and where the acquisition part 91 acquires a size of each of the plurality of sheets S, the control part 94 performs the second feed control. That is, in that case, the control part 94 controls the one or more conveyance rollers 52 to remove the sheet S from the drawer unit 5. Accordingly, there is an advantage that the sheet S is easily moved to a position where the sheet S will not be damaged when the drawer unit 5 is pulled out regardless of the size of the sheet S stopped in a form of being located in both the drawer unit 5 and the apparatus main body 10A in a case where a jam occurs.

In the present embodiment, the drawer unit 5 is a unit including the conveyance path 51 between the sheet conveyance part 4 and the output tray 6, though not limited thereto. For example, the drawer unit 5 may be configured as a unit including the sheet conveyance path 45 of the sheet conveyance part 4. Moreover, for example, in a case where the image forming apparatus 10 includes a conveyance path for double-sided printing, the drawer unit 5 may be configured as a unit including the conveyance path. It should be noted that the drawer unit 5 is not limited to one, but may be multiple. In a case where there is a plurality of drawer units 5, the sheet feed control system 100 only needs to perform the first feed control or the second feed control by controlling the one or more conveyance rollers 52 for each drawer unit 5.

[Notes of disclosure] The outline of the disclosure extracted from the above-mentioned embodiments will be given below. Note that the configurations and processing functions described in the following notes can be arbitrarily selected and combined.

### Note 1

A sheet feed control system, including:
an acquisition part that acquires a size of a sheet to be conveyed;
a first detection part that detects a jam of the sheet; and
a control part that performs, in a case where the jam is detected, either first feed control or second feed control in accordance with the size of the sheet, the first feed control being control to convey the sheet to a position to fit inside a drawer unit, the second feed control being control to convey the sheet to a position to fit outside the drawer unit, and the drawer unit including a conveyance path for the sheet and being capable of being pulled out in a direction that intersects with a conveyance direction of the sheet from an apparatus main body of the image forming apparatus.

### Note 2

The sheet feed control system according to Note 1, in which
the control part performs the second feed control in a case where a length of the sheet in the conveyance direction is longer than a length of the drawer unit in the conveyance direction.

### Note 3

The sheet feed control system according to Note 2, in which
in a case where the control part performs the second feed control, the control part drives all conveyance rollers located inside the drawer unit.

### Note 4

The sheet feed control system according to any one of Notes 1 to 3, in which
the control part performs either the first feed control or the second feed control in a case where the length of the sheet in the conveyance direction is shorter than the length of the drawer unit in the conveyance direction.

### Note 5

The sheet feed control system according to Note 4, in which
the drawer unit includes
a first conveyance roller located on a farther upstream side than a center of the drawer unit in the conveyance direction, and
a second conveyance roller located on a farther downstream side than the center of the drawer unit in the conveyance direction, and
in a case where the control part performs the first feed control, the control part drives the first conveyance roller and stops the second conveyance roller.

### Note 6

The sheet feed control system according to Note 4 or 5, in which
the drawer unit includes
   a first conveyance roller located on a farther upstream side than a center of the drawer unit in the conveyance direction, and
   a second conveyance roller located on a farther downstream side than the center of the drawer unit in the conveyance direction, and
in a case where the control part performs the second feed control, the control part stops the first conveyance roller and drives the second conveyance roller.

### Note 7

The sheet feed control system according to any one of Notes 1 to 6, further including
a second detection part that detects presence/absence of the sheet at a first position on a farther upstream side in the conveyance direction than the drawer unit and a second position on a farther downstream side in the conveyance direction than the drawer unit, in which
the control part performs either the first feed control or the second feed control in a case where the second detection part detects that at least a portion of the sheet is present between the first position and the second position.

### Note 8

The sheet feed control system according to any one of Notes 1 to 7, in which
the control part performs the second feed control in a case where a plurality of the sheets of different sizes is continuously conveyed and where the acquisition part acquires a plurality of sizes of the sheets.

### Note 9

A sheet feed control method, including:
an acquisition step of acquiring a size of a sheet to be conveyed;
a detection step of detecting a jam of the sheet; and
a control step of performing, in a case where the jam is detected, either first feed control or second feed control in accordance with the size of the sheet, the first feed control being control to convey the sheet to a position to fit inside a drawer unit, the second feed control being control to convey the sheet to a position to fit outside the drawer unit, and the drawer unit including a conveyance path for the sheet and being capable of being pulled out in a direction that intersects with a conveyance direction of the sheet from an apparatus main body of the image forming apparatus.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A sheet feed control system, comprising:
an acquisition part that acquires a size of a sheet to be conveyed;
a first detection part that detects a jam of the sheet; and
a control part that performs, in a case where the jam is detected, either first feed control or second feed control in accordance with the size of the sheet, the first feed control being control to convey the sheet to a position to fit inside a drawer unit, the second feed control being control to convey the sheet to a position to fit outside the drawer unit, and the drawer unit including a conveyance path for the sheet and being capable of being pulled out in a direction that intersects with a conveyance direction of the sheet from an apparatus main body of the image forming apparatus.

2. The sheet feed control system according to claim 1, wherein
the control part performs the second feed control in a case where a length of the sheet in the conveyance direction is longer than a length of the drawer unit in the conveyance direction.

3. The sheet feed control system according to claim 2, wherein
in a case where the control part performs the second feed control, the control part drives all conveyance rollers located inside the drawer unit.

4. The sheet feed control system according to claim 1, wherein
the control part performs either the first feed control or the second feed control in a case where the length of the sheet in the conveyance direction is shorter than the length of the drawer unit in the conveyance direction.

5. The sheet feed control system according to claim 4, wherein
the drawer unit includes
a first conveyance roller located on a farther upstream side than a center of the drawer unit in the conveyance direction, and
a second conveyance roller located on a farther downstream side than the center of the drawer unit in the conveyance direction, and
in a case where the control part performs the first feed control, the control part drives the first conveyance roller and stops the second conveyance roller.

6. The sheet feed control system according to claim 4, wherein
the drawer unit includes
a first conveyance roller located on a farther upstream side than a center of the drawer unit in the conveyance direction, and
a second conveyance roller located on a farther downstream side than the center of the drawer unit in the conveyance direction, and
in a case where the control part performs the second feed control, the control part stops the first conveyance roller and drives the second conveyance roller.

7. The sheet feed control system according to claim 1, further comprising
a second detection part that detects presence/absence of the sheet at a first position on a farther upstream side in the conveyance direction than the drawer unit and a second position on a farther downstream side in the conveyance direction than the drawer unit, wherein
the control part performs either the first feed control or the second feed control in a case where the second detection part detects that at least a portion of the sheet is present between the first position and the second position.

8. The sheet feed control system according to claim 1, wherein
the control part performs the second feed control in a case where a plurality of the sheets of different sizes is continuously conveyed and where the acquisition part acquires a size of each of the plurality of sheets.

9. A sheet feed control method, comprising:
an acquisition step of acquiring a size of a sheet to be conveyed;
a detection step of detecting a jam of the sheet; and
a control step of performing, in a case where the jam is detected, either first feed control or second feed control in accordance with the size of the sheet, the first feed control being control to convey the sheet to a position to fit inside a drawer unit, the second feed control being control to convey the sheet to a position to fit outside the drawer unit, and the drawer unit including a conveyance path for the sheet and being capable of being pulled out in a direction that intersects with a conveyance direction of the sheet from an apparatus main body of the image forming apparatus.
